(19) United States
(12) Patent Application Publication
(10) Pub. No.: US 2026/0309025 A1
(43) Pub. Date: Oct. 8, 2026

(54) Integrated Multi-Physics Sensing for Real-Time Look-Ahead While Drilling

(71) Applicant: VIRGINIA TECH INTELLECTUAL PROPERTIES, INC., Blacksburg, VA (US)

(72) Inventors: Joseph Vantassel, Blacksburg, VA (US); Russell Green, Blacksburg, VA (US); Adrian Rodriguez-Marek, Blacksburg, VA (US); Erik Westman, Blacksburg, VA (US)

(21) Appl. No.: 19/566,673

(22) Filed: Mar. 13, 2026

Related U.S. Application Data
(60) Provisional application No. 63/771,519, filed on Mar. 13, 2025.

(51) Int. Cl. E21B 47/113; G01V 1/00; G01V 3/30

(52) U.S. Cl. CPC E21B 47/113; G01V 1/003; G01V 3/30

(57) ABSTRACT

Various examples are provided related to real-time look-ahead during subsurface drilling. In one example, a system for multiphysics sensing during subsurface drilling includes a sensing capsule coupled between a drill string and a drilling bit and a computing device in communication with the sensing capsule. The sensing capsule can include an electromagnetic sensing system and a seismic sensing system. The computing device can store a multiphysics intelligent sensing system application that can cause the computing device to obtain sensor data from the electromagnetic sensing system and the seismic sensing system during drilling along a route; determine the presence or absence of an obstruction along the route using the sensor data from the electromagnetic sensing system and the seismic sensing system, the determination provided by a trained intelligent obstruction model; and provide an indication of the obstruction to an operator of the drill string and drill bit.

### CROSS REFERENCE TO RELATED APPLICATIONS

This application claims priority to, and the benefit of, U.S. provisional application entitled “Integrated Multi-Physics Sensing for Real-Time Look-Ahead While Drilling” having Ser. No. 63/771,519, filed Mar. 13, 2025, which is hereby incorporated by reference in its entirety.

### STATEMENT REGARDING FEDERALLY SPONSORED RESEARCH OR DEVELOPMENT

This invention was made with government support under DE-AR0001851 awarded by the Department of Energy. The Government has certain rights to this invention.

### BACKGROUND

Near-surface drilling operations, particularly those involving trenchless construction methods, face significant challenges due to the complexities of the shallow subsurface environment (depths <10 m). The complexity at the near-surface is the result of both human activity and complex geological formations. This combination of effects creates a high-risk scenario for drilling projects, with the potential for substantial costs and delays. A primary challenge to the application of trenchless technology is the prevalence of undocumented or poorly documented buried utilities and other obstructions related to human activity. Decades of infrastructure development have resulted in a dense network of underground utilities (water, sewer, electricity, etc.), often with incomplete or inaccurate records. Additionally, even when the documentation of existing utilities is reliable, the shallow subsurface frequently contains undocumented obstacles such as construction debris, abandoned foundations, and decommissioned utilities.

These potential obstructions pose a significant risk of utility strikes and drilling disruptions, contributing to an estimated $30 billion in annual costs within the United States alone. Furthermore, the geological structure of the near-surface is characterized by its heterogeneity and rapid variability. The composition of the shallow subsurface can change drastically over short distances (e.g., one meter or less), with a single site potentially encompassing sand, clay, boulders, voids, and bedrock. This variability can significantly impact drilling efficiency, as different materials need different drilling techniques and encounter varying levels of resistance. Drilling through heterogeneous geomaterials is particularly challenging and costly, potentially leading to project delays and equipment damage.

### SUMMARY

Aspects of the present disclosure are related to real-time look-ahead during subsurface drilling. In one aspect, among others, a system for multiphysics sensing during subsurface drilling, comprises: a sensing capsule coupled between a drill string and a drilling bit, the sensing capsule comprising an electromagnetic sensing system and a seismic sensing system; and at least one computing device communicatively coupled to the sensing capsule, the at least one computing device comprising a processor and memory storing a multiphysics intelligent sensing system (MISS) application that when executed by the processor causes the at least one computing device to: obtain sensor data from the electromagnetic sensing system and the seismic sensing system during drilling along a route; determine the presence or absence of an obstruction along the route based at least in part upon the sensor data from the electromagnetic sensing system and the seismic sensing system, the determination provided by a trained intelligent obstruction model; and providing an indication of the obstruction to an operator of the drill string and drill bit. In one or more aspects, the electromagnetic sensing system can comprise a look-ahead radar system. The look-ahead radar system can be a pulsed radar or a frequency modulated continuous wave (FMCW) radar. The seismic sensing system can comprise a mechanical shaker configured to produce an impulse and one or more sensors distributed about the sensing capsule. The one or more sensors can comprise one or more accelerometer, one or more geophone, or both. The one or more sensors can comprise an array of sensors distributed about the sensing capsule.

In various aspects, the system can further comprise a surface or near-surface sensor communicatively coupled to the at least one computing device, wherein the presence or absence of an obstruction along the route is further determined based upon sensor data from the surface or near-surface sensor. The surface or near-surface sensor can be a distributed acoustic sensing system (DAS). The DAS can comprise three or more sensors providing sensor data. The trained intelligent obstruction model can comprise parallel frequency and time domain paths that are concatenated together. The trained intelligent obstruction model can be initially trained with simulated subsurface data. The trained intelligent obstruction model can comprise a plurality of convolutional layers. The trained intelligent obstruction model can determine a distance to the obstruction. The trained intelligent obstruction model can determine a size of the obstruction. The trained intelligent obstruction model can determine a composition of the obstruction.

In another aspect, a method for multiphysics sensing during subsurface drilling comprises receiving, by a processing device, sensor data from a sensing capsule coupled between a drill string and a drilling bit during drilling along a route, the sensing data comprising electromagnetic sensing data and stress wave sensor data; detecting, by a multiphysics intelligent sensing system (MISS) application executed by the processing device, the presence of an obstruction along the route based at least in part upon the sensor data; in response to the detection of the obstruction, providing a distance and direction from the drilling bit to the obstruction; and adjusting operation of the drill string and drilling bit to change the route and avoid the obstruction. In one or more aspects, the electromagnetic sensing data can comprise pulsed radar data. The stress wave sensor data can comprise impulse data generated by a mechanical shaker. The method can further comprise receiving sensor data from a distributed acoustic sensing system (DAS) disposed on or near a surface. The MISS application can comprise a trained intelligent obstruction model detects the presence of the obstruction based upon the received sensor data. The method can comprise providing a visual indication of the obstruction with respect to the drilling bit.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of an application to identify and avoid obstructions along a planned drilling alignment with multiphysics sensing, in accordance with various embodiments of the present disclosure.

FIG. 2 is a schematic diagram illustrating an example of the sensing capsule including multiphysics sensors and sources, in accordance with various embodiments of the present disclosure.

FIG. 3 is a flowchart illustrating an example of a decision making process when performing subsurface drilling with multiphysics sensing, in accordance with various embodiments of the present disclosure.

FIG. 4 illustrates an example of a multiphysics intelligent sensing system (MISS) application architecture, in accordance with various embodiments of the present disclosure.

FIGS. 5A-5C illustrate an example of an intelligent model architecture, in accordance with various embodiments of the present disclosure.

FIG. 6 illustrates examples of probability mass functions that define the subsurface model in terms of the (a) number of layers, (b) range of mean shear wave velocity (Vₛ), (c) number of utilities, and (d) depth to the center of a utility, in accordance with various embodiments of the present disclosure.

FIG. 7 illustrates an example of a procedure for simulating the three interlayer boundaries of a four-layered model, in accordance with various embodiments of the present disclosure.

FIG. 8 illustrates 16 examples of Vₛ images from the testing dataset, in accordance with various embodiments of the present disclosure.

FIG. 9 illustrates an example of data augmentations used in terms of Vₛ images and seismic wavefield, in accordance with various embodiments of the present disclosure.

FIG. 10 illustrates an example of a probability mass function for the normalized standard deviation of random white noise added through time-domain jittering augmentation, in accordance with various embodiments of the present disclosure.

FIG. 11 illustrates 16 examples of Vₛ images predicted by the proposed AI model (in the same order as FIG. 8), in accordance with various embodiments of the present disclosure.

FIG. 12 illustrates pixel-by-pixel residual images for the 16 Vₛ images of FIG. 11, in accordance with various embodiments of the present disclosure.

FIG. 13 illustrates a comparison of mean absolute percent error for the proposed AI model and a retrained CNN model, in accordance with various embodiments of the present disclosure.

FIG. 14 illustrates an example of average mean absolute percent error computed for each pixel across the testing datasets using the proposed AI model and the retrained CNN model, in accordance with various embodiments of the present disclosure.

FIG. 15 illustrates an example of shear wave velocity profile on real field data using the proposed AI model and shear wave refraction, in accordance with various embodiments of the present disclosure.

FIG. 16 illustrates examples of results of prediction robustness test for four AI predictive models, in accordance with various embodiments of the present disclosure.

FIG. 17 illustrates examples of results of wavefield prediction consistency test for the four AI predictive models, in accordance with various embodiments of the present disclosure.

FIG. 18 is a schematic block diagram of an example of a processing or computing device, in accordance with various embodiments of the present disclosure.

### DETAILED DESCRIPTION

Disclosed herein are various examples related to real-time look-ahead during subsurface drilling. Reference will now be made in detail to the description of the embodiments as illustrated in the drawings, wherein like reference numbers indicate like parts throughout the several views.

The combined risk of encountering undocumented obstructions and navigating complex geological formations makes near-surface drilling operations expensive and unpredictable. Existing methods, such as traditional trenching, are disruptive and costly, needing excavations from the ground surface before installation and extensive restoration efforts after the work is complete. While horizontal directional drilling and other trenchless methods offer less surface disruption, they are limited by the challenging environment of the near-surface (discussed previously). These challenges are particularly evident in critical infrastructure projects, such as the undergrounding of electrical transmission lines. Weather-related power outages, primarily resulting from damage to transmission lines, cost the U.S. economy an estimated $150 billion annually. Undergrounding these lines can significantly reduce outages; however, the high cost and risks associated with current drilling and trenching methods have hindered widespread implementation. Therefore, there is a clear need for a technology that can mitigate the risks and reduce the costs associated with near-surface drilling. A system capable of providing real-time, look-ahead sensing would enable drill operators to identify and avoid subsurface obstructions and navigate complex geological formations. Such a technology would significantly enhance drilling efficiency, reduce costs, and improve safety, making critical infrastructure projects like undergrounding electrical transmission lines more feasible and cost-effective.

The disclosure addresses this need by providing a multi-physics sensing system capable of delivering real-time, look-ahead information during drilling operations, including shallow (i.e., near-surface) drilling operations. This includes trenchless construction methods for installing underground utilities and structures with minimal (and preferably no) surface disruption. These methods are in contrast to those methods that need “trenching”, excavation from the ground surface, to install the associated utility or structure. The technology is designed for applications in the shallow subsurface, typically less than 10 meters in depth, as is typical of the fields of geotechnical and utility engineering. The disclosed technology enables the acquisition and integration of data from two complementary sensing modalities (i.e., multi-physics sensing) to provide real-time, look-ahead information at least 1 m in advance of the drilling processes. The technology enables drill operators to detect and identify potential subsurface obstructions before encountering them, thereby facilitating proactive adjustments and mitigating drilling disruptions. These obstructions may be of geologic nature (e.g., voids, sinkholes, boulders, rock, etc.) or from human activity (e.g., current or abandoned utilities, building foundations, construction or demolition debris, etc.).

The technology can be used in applications involving small-diameter drilling bores, for example those used with common trenchless construction methods such as horizontal directional drilling, micro tunneling, jack and bore among others, but is adaptable to larger-diameter bores. The technology is adaptable to various subsurface conditions, including diverse soil and rock compositions and the presence or absence of water in the subsurface. The technology does not impede or modify the drilling process. Instead, the technology can be integrated with existing drilling equipment to provide real-time, actionable intelligence to drill operators, preventing costly delays and potential equipment damage and increasing worker safety. It is designed for near-surface drilling applications and the identification of near-surface drilling obstructions. It is not explicitly intended for applications that utilize deeper subsurface operations or operations that typically occur in areas absent of obstructions. Such environments where the application of the technology is not intended include those that are characteristic of petroleum, hydrocarbon exploration, or mineral extraction.

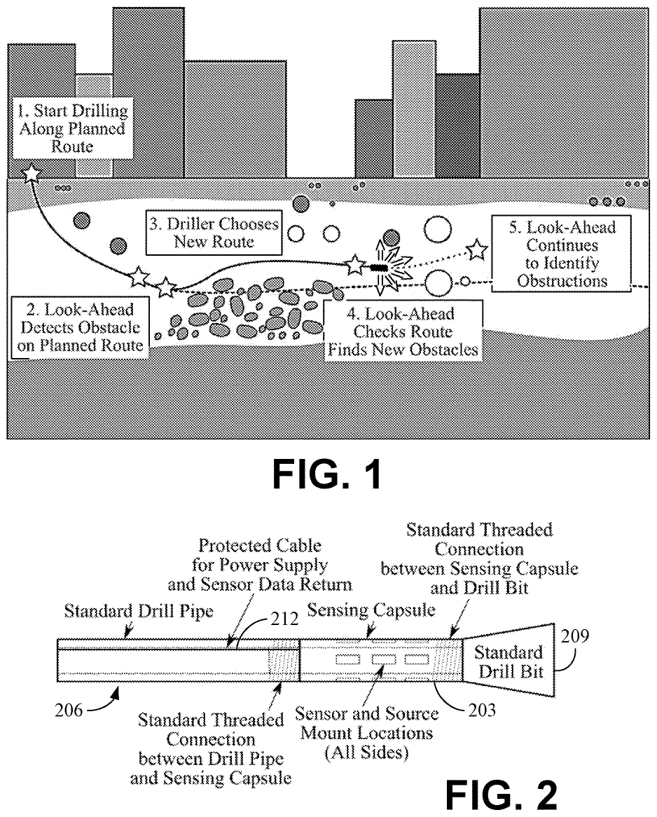

A novel sensing procedure for real-time, look-ahead information during subsurface drilling operations is provided. FIG. 1 illustrates an example of an application to identify and avoid obstructions along a planned drilling alignment. Initially, drilling can start along a planned route. Look-ahead sensing is employed to detect potential obstructions along the route as the drilling progresses. When the look-ahead detects an obstacle on the planned route, the driller can choose a new route to avoid the obstacle. As the drilling progresses along the new route, the look-ahead can continue to check the route to find and identify potential obstacles along the path. The new route can be adjusted to redirect the drilling back towards the original planned route.

This procedure employs a sensing capsule integrated directly behind the drilling bit within the drill string, ensuring minimal disruption to the drilling process. FIG. 2 is a schematic diagram illustrating an example of the sensing capsule 203 that holds the multiphysics sensors and sources. For example, the sensing capsule 203 can incorporate two distinct sensing systems, leveraging complementary physical mechanisms: (visco) elastodynamics and electromagnetics. The first system can utilize mechanical shakers that can be electrically driven to generate stress-wave vibrations and receivers to measure the returning signals. A linear array of accelerometers can be used to resolve the direction of incoming reflections. The addition of geophones can enhance the data collection. For example, a combination of accelerometers with a 1 m interval and geophones with a 0.25 interval was found to be effective. The second system can employ radar sources (e.g., ground penetrating radar) to transmit electromagnetic waves and antennas to receive the reflected signals. By simultaneously acquiring and fusing data from these two sensing modalities, the system can enable comprehensive subsurface characterization, predicting the type of materials surrounding and ahead of the drilling operation. The two sensing systems of the sensing capsule 203 can be supplemented by using the vibration from the drill head itself as a powerful (visco) elastodynamic source and/or using (visco) elastodynamic or electromagnetic sensors deployed at or near the ground surface. These additional sensors can provide new observables to better contain the look-ahead prediction. This multi-physics approach, combining (visco) elastodynamic and electromagnetic sensing, provides enhanced sensitivity to potential obstructions that could impede drilling progress, and allows operation in diverse subsurface conditions. Notably, this integrated (visco) elastodynamic and electromagnetic sensing approach has not been previously implemented at any scale, offering a unique and effective solution for look-ahead during subsurface drilling. The successful application of this multi-physics sensing is enabled by the ability to fuse data from two or more sensing modalities into a comprehensible multi-physics sensing prediction of whether obstructions exist in front of the drill face. The disclosed technology can fuse this data using an intelligent obstruction model that incorporates standard signal processing with a pre-trained artificial intelligence model. The intelligent obstruction model can receive data from the two or more sensing modalities and produce an easily understood prediction for the drill operator. This prediction is expected to occur in the field (i.e., in close proximity to the drilling operation) as the quantity of data being received would likely prevent a cloud-based system to be effective. In its simplest form this prediction can include a binary-type prediction (e.g., a utility is or is not detected). The use of the intelligent obstruction model is important to converting the large volumes of data being received in real-time (i.e., seconds) to continuously provide the drill operator feedback regarding their selected drilling alignment.

As illustrated in FIG. 2, the sensing capsule 203 comprises a hardened sensing capsule, which can be constructed of steel or other appropriate hardened material (e.g., metal or alloy), designed to be integrated into the drill string 206 immediately behind the drilling bit 209. The sensing capsule 203 can house both electromagnetic and seismic sources and receivers, enabling simultaneous multi-physics data acquisition. The sensing capsule 203 can be engineered to securely hold the sensors and withstand the rigors of drilling operations. Standard threaded connections can facilitate seamless integration with the drill string 206 and drilling bit 209, ensuring no interference with the drilling process. Data collected by the sensors can be transmitted to the ground surface in real-time via a shielded cable 212, providing continuous feedback to the operator. The shielded cable 212 provides electricity to the sensing capsule 203 and relays data back to the ground surface to an intelligent obstruction model.

The seismic sensing system can utilize mechanical shaker-type devices as sources, capable of generating stress-wave vibrations within the frequency range up to 5 kHz. Depending on the application, one or multiple shaker devices can be employed, with multiple sources being the preferred for enhanced signal strength. The timing of shaker activation can be controlled via the shielded cable 212. Seismic receivers, such as commercially available accelerometers or geophones, are sensitive to frequencies up to 5 KHz range. The accelerometers and geophones can be spaced at intervals (e.g., 1 m and 0.25 m intervals, respectively) for measurement collection. Again, one or multiple sensors can be mounted on the sensing capsule 203, with multiple sensors being used for improved data acquisition. Signals (SNR >3) were detectable out to 6 meters with the accelerometers producing consistently higher SNR than the geophones, due to their broader frequency range. The testing indicated a coherence above 0.5 in the 200-1200 Hz, with a very strong coherence over 200-800 Hz.

The electromagnetic sensing system can employ a ground penetrating radar (GPR) unit, capable of transmitting and receiving signals in the frequency range of 100 to 1000 MHz. The GPR source can be aligned to transmit electromagnetic waves directly ahead of the drill string. The received electromagnetic signals, along with the seismic data, can be transmitted back to the ground surface via the shielded cable 212 for processing.

The radar can be implemented as a pulsed radar system or a frequency modulated continuous wave (FMCW) radar. The systems can be implemented as a system-on-chip design such as a FPGA with signals being provide through the shielded cable 212 for transmission and return signals being communicated back for processing. An RF front end can provide amplification of the signals for transmission via the antenna.

The seismic and electromagnetic systems on the sensing capsule 203 can be supplemented in two ways. First, the drilling process itself and the vibrations it produces as it advances through the subsurface can be used as a seismic source. Second, the sensors deployed on the sensing capsule can be supplemented with sensors at the ground surface (e.g., laying on or weighted) or near the ground surface (e.g., buried directly in or within a pipe near the ground surface). Such sensors can include traditional velocity transducers (e.g., geophones), accelerometers, or distributed fiber optic sensing (DFOS). In the case of DFOS this can utilize either surface (or near surface) deployed fiber optic cable above the drilling alignment or commandeering existing telecommunication fiber as strain sensing elements. One or more supplemental sensors (e.g., 3 or more, or in a range from 3 to 30) can be deployed at or near the ground surface to provide additional data. The supplemental data can be provided along with the data from the sensing capsule 203 to the intelligent obstruction model.

The fusion of seismic and electromagnetic data enables comprehensive subsurface characterization. Electromagnetic sensing excels in non-conductive materials (e.g., dry soil, rock), providing high-resolution detection of conductive targets (e.g., metallic utilities). However, its effectiveness is reduced in conductive environments (e.g., wet clay and silt), and it is less sensitive to non-conductive targets (e.g., plastic). Conversely, seismic sensing is effective in both conductive and non-conductive materials, providing reliable data regardless of moisture content or the presence or absence of ground water. While seismic signals are typically lower frequency and therefore have lower detection resolutions than electromagnetic waves, they excel at detecting materials with substantial stiffness differences, such as concrete within soil. The complementary nature of these sensing modalities ensures robust data acquisition in diverse subsurface conditions.

The sensing system generates a significant volume of data, exceeding the capacity of a human operator to understand and interpret in real-time. Furthermore, the data volume is impractical for real-time inversion using traditional inversion techniques to reconstruct the subsurface profile. Therefore, advanced intelligent processing techniques are employed to rapidly prepare the information in a format easily understood by the drill operator. First, the data is pre-processed using signal processing techniques, including filtering, detrending, and windowing, among others. The pre-processed signal is then passed to a previously trained intelligent obstruction model hosted on a field-deployed computing or processing device (e.g., a computer) that is part of the multi-physics sensing system. The obstruction model, capable of predicting the presence or absence of an obstruction, produces a prediction within seconds of receiving the data. In its simplest form the prediction can be a binary prediction (e.g., an obstruction is or is not present). This prediction can occur in a continuous loop, providing real-time feedback to the drill operator.

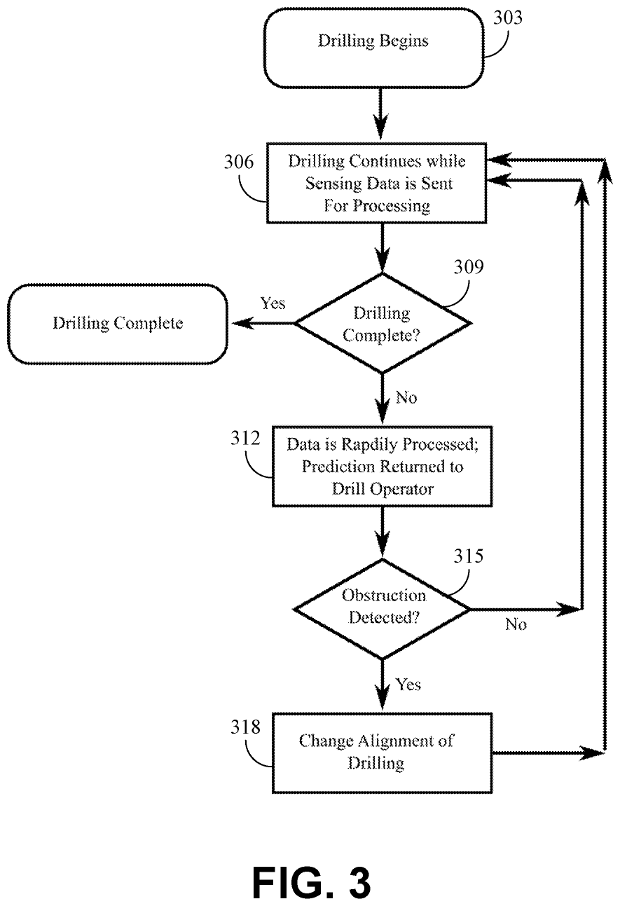

FIG. 3 is a flowchart illustrating an example of a decision making process when performing subsurface drilling. After drilling begins at 303, sensing data is sent for processing at 306 while the drilling continues. If the drilling is not complete at 309, then the data is rapidly processed at 312. If the system warns of a potential obstruction 315, the operator has time to select a new drilling alignment at 318 or halt drilling to gather further information. This technology provides a vital early warning system, allowing the drill operator to avoid potential utility strikes and cross bores before they occur without delaying or interfering with the drilling process. If no obstruction is detected at 315, then sensing data continues to be sent for processing at 306 while the drilling continues.

### Operation

The sensing capsule 203, containing both electromagnetic and seismic sensors, can be positioned between the drill bit 209 and the drill string 206. A shielded cable 212, carrying power to the sensing capsule 203 and transmitting data back to the surface, is routed through the drill string 206. Upon initiating drilling operations, power is supplied to the sensing capsule 203, activating the sensors. Data from the sensing capsule 203 can be transmitted in real-time to a computing or processing device (e.g., computer) equipped with a memory buffer for data storage and processing. If additional surface-based sensors are used they can also be activated and their data also streamed to the same computational-resource as the data from the sensing capsule 203.

The obstruction model, residing on the computing or processing device, can be activated and prepared to receive data. As data streams from the sensing capsule 203 and potentially other surface based sensors, the obstruction model can perform real-time, near real-time, or semi-continuous predictions, typically at intervals of approximately one second, though this can be adjusted based on available computational resources and the specific prediction model. In its simplest form the obstruction model's output, a binary prediction indicating the presence or absence of an obstruction ahead of the drill. The prediction can be presented to the drill operator.

The prediction can be visualized in various formats, such as a simple green light for “continue drilling” and a red light for “obstruction detected.” Alternatively, more detailed graphical representations of subsurface conditions can be displayed that indicate the distance to, size of (e.g., diameter of pipe or cable or dimensions of object), and composition of (e.g., material such as concrete, steel, fired clay, PVC, wood, granite, brick, etc.) the obstruction. The geometry of (e.g., cylindrical, planar, spherical) and/or orientation of (e.g., horizontal, vertical, diagonal) the obstruction can also be indicated. Drilling continues until the operator determines the drilling operation is complete. The operator can retain full control over how to respond to the sensor predictions, allowing for adjustments to the drilling path or halting operations for further investigation as needed. The system does not interfere with the drilling process.

### Multiphysics Intelligent Sensing System (MISS)

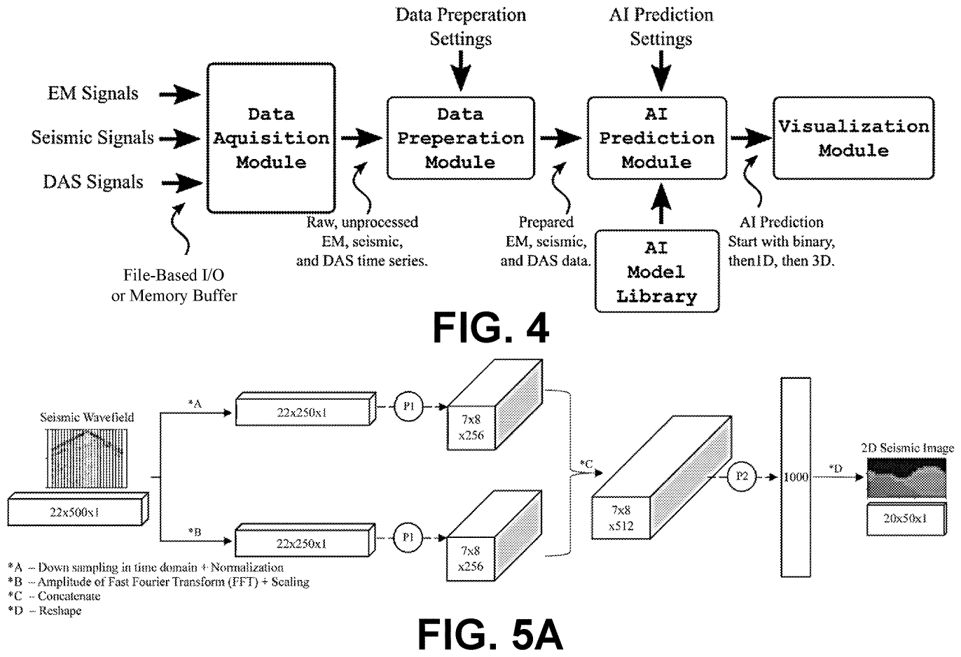

The multiphysics intelligent sensing system (MISS) is a look-ahead sensing platform that utilizes seismic and electromagnetic waves to detect obstacles ahead of the drill face. The MISS application provides a data processing pipeline that intakes raw sensor data and returns readily understood visualizations of obstructions ahead of the drill face. To accomplish this the MISS application can include four primary modules: data acquisition, data preparation, AI prediction, and result visualization. FIG. 4 illustrates an example of the MISS application architecture.

Data Acquisition Module. The data acquisition module 403 can be configured to manage loading the raw sensor data. The MISS system has three primary sensing systems each with their own associated data formats and organization. The first sensing system is the electromagnetic (EM) sensing system comprising a ground penetrating radar source and antenna. The primary data includes the description of the target, propagation medium, radar waveform, and the associated EM returns on the antenna. The EM return data comprises samples of a return waveform signal amplitude as a function of distance from the radar antenna (e.g., A scans) synthesized from the stepped frequency radar waveform saved in a standard binary format with test run details in metadata. The second sensing system is the seismic sensing system comprising seismic sources and receivers. The primary data includes the waveform emitted by the source and the associated seismic returns on the receivers. Disk-based input/output (I/O) can be used to transfer data between, e.g., a MATLAB-based acquisition system and a Python-based data pre-dilatancy associated with the disk-based I/O. The third sensing system is a distributed acoustic sensing system (DAS) composed of a fiber optic interrogator unit (IU) and its associated control software. Disk-based I/O can be utilized to transfer data recorded by the IU into the data-acquisition module. Alternatively, the disk-based I/O can be replaced with direct access to the IU's memory buffer. This feature can provide a significant acceleration between acquisition and processing for real-time monitoring. For all three systems the data acquisition module 403 can facilitate loading raw data from the disparate formats and sources (e.g., EM signals, seismic signals, DAS signals) into the MISS application.

Data Preparation Module. The data preparation module 406 can be configured to transform the raw data output by the data acquisition module 403 and prepare it for transfer to the AI prediction module 409. The data preparation module 406 can include signal processing tools including filtering, detrending, cross-correlation, frequency-domain transformation, etc. that can be applied to prepare the raw data captured in the field. The exact types of signal processing tools applied to the data can be determined in conjunction with AI model development, however the above includes those that are determined to be of value. As not all signal processing tools may be needed, the data preparation module 406 can be controlled by a data preparation settings object that provides a means to document the settings used.

AI Prediction Module. The AI prediction module 412 can be configured to take the prepared data and make predictions. The prediction module 412 can be developed such that it can draw from a library of trained AI obstruction models 415. The AI prediction module 412 can be designed to accept the prepared data as input, pass those inputs through the loaded AI obstruction model, and return a standardized prediction. For example, the AI predictions can be binary (e.g., obstruction ahead/no obstruction ahead), 1D predictions (potential obstruction+distance), or 3D predictions. The AI prediction should be fast and able to be performed on the computing or processing device (e.g., an edge computing resource or GPU).

Visualization Module. The visualization module 418 can be configured to communicate the output of the AI prediction module 412 in, e.g., standard figures. For example, the visualization module 418 can include a toolkit of 1D/2D/3D visualization tools for communicating the information. Having a dedicated module for visualization allows for standardization of prediction outputs made by different intelligent obstruction models.

### AI Predictive Model

Geotechnical imaging needs to detect anomalies, but also to create a complete image of the subsurface. Furthermore, the depth range, velocity range, and level of heterogeneity encountered on geotechnical projects often prevents the direct translation of these prior efforts. However, there has been progress around developing data-driven imaging for geotechnical applications. A convolutional neural network (CNN) has been used to develop starting models for 2D full waveform inversion (FWI). It has been demonstrated that a CNN could perform as-well-as and in some cases better than a traditional FWI. Here, a new data-driven predictive model for predicting 2D subsurface shear wave velocity (Vₛ) images to a depth of 20 m using seismic waveforms acquired on a 24-channel array with a single source location. Solutions to four challenges when developing data-driven predictive models for subsurface imaging are highlighted. First, challenges with model generalization can be addressed by a novel, multimodal AI model architecture that operates on both the time- and frequency-domain representations of the seismic wavefield. Second, the lack of training data that spans the full range of near-surface geologic conditions can be addressed by developing a new 100,000 sample training set composed of complex soil models containing between 1 and 8 layers. Third, four physics-informed data augmentations were developed to mitigate the differences between synthetic and real seismic data. Fourth, two data consistency tests were developed to quantitatively evaluate if the predicted model's results were reliable when the true subsurface Vₛ image is unknown. To quantify the improvement of the new AI model architecture, the model's predictive power was compared to a retrained version of the CNN architecture. To demonstrate the model's ability to predict on real-world experimental datasets the model's prediction was showcased at a site, and compared with independent measurements at the site.

Developing the Model Architecture. While often conflated, AI, machine learning (ML), and deep learning (DL) are related but distinct terms. AI is a broad field aiming to create machines that can simulate human intelligence, encompassing various approaches, including the subfields of ML and DL. ML refers to algorithms that enable systems to learn and improve from experience, without explicit programming. DL, a subfield of ML, involves the use of deeply-layered networks inspired by the structure of the human brain. DL has shown an exceptional ability to solve perceptual tasks, such as image classification, image segmentation, text-to-image, and text-to-text. In this work, it is proposed that a DL model can learn features from the seismic wavefield observed at the ground surface to predict the 2D subsurface Vₛ image.

Previously developed AI-based modeling architectures for shallow subsurface imaging have focused on using a pure time-domain or frequency-velocity domain representations of the seismic wavefield. For the development of the current architecture, a multi-modal architecture was developed that accepts time- and frequency-domain representations of the seismic wavefield. This was done as some seismic phenomena are more-easily identifiable in the time domain (e.g., body wave first arrivals) whereas other phenomena are more-easily identifiable in the frequency domain (e.g., surface wave phase velocity). By using both together, the learning task for the AI model may be simplified, allowing a simpler model architecture to be utilized and model development to be accelerated. In addition, by providing both a time and frequency domain representation of the seismic wavefield, some redundancy in the information provided to the AI model is allowed making it more robust in its prediction of real data. For example, if a strong source of narrow-band noise (e.g., manufacturing equipment) is nearby this will contaminate the full time-domain representation, however, this will only appear as a narrow peak in the frequency-domain representation. To quantitatively determine if the multi-modal model is able to improve on the performance of previously developed uni-modal models, its performance was compared to a time-domain only model but retrained on the same dataset as the multi-model model to create a fair comparison.

The development of a DL model architecture for a new task involves selecting between numerous network layer options to find the combination that results in the best (or most acceptable) performance on a validation set (i.e., data not used for training or testing). In terms of layer types, DL architectures comprising convolutional layers, densely connected layers, recurrent neural network layers, long short-term memory layers, dropout layers, normalization layers, and pooling layers were considered. For developing the multi-modal input, different input pipelines, that varied the length and receiver positions of the time-domain signals and the form of the frequency-domain input (e.g., only amplitude, only phase, and both amplitude and phase) were considered. For this study, 45 different model architectures were evaluated to select the one for use. The selected model stood out in terms of its performance on the validation set, trainable parameter count, and time to prediction.

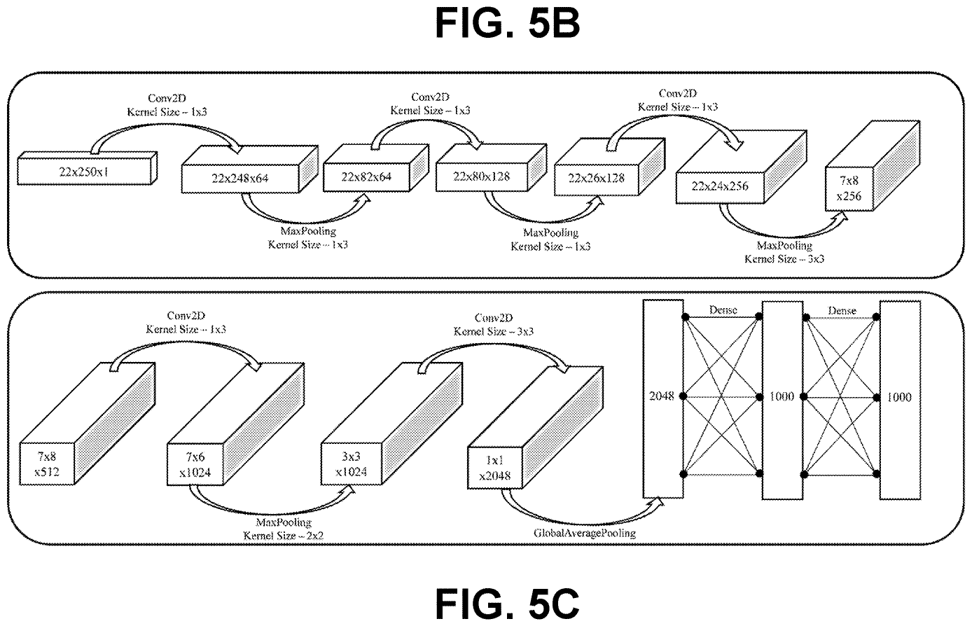

The final AI predictive model architecture is illustrated in FIGS. 5A-5C. FIG. 5A is a schematic diagram of the an artificial intelligence model architecture used to predict a 20 m deep and 50 m wide 2D seismic image from a seismic wavefield comprising 22 receivers recording for 0.5 seconds at 1000 Hz. Components P1 and P2 of FIG. 5A are shown in detail in FIG. 5B and FIG. 5C, respectively. P1, shown in FIG. 5B, comprises three 2D convolution layers with a kernel size of 1×3 and three maximum pooling layers of variable kernel size. P2, shown in FIG. 5C, comprises two 2D convolutional layers, a max pooling layer, a global average pooling layer, and two densely connected layers. Each box shown in the figure represents a tensor with the dimensions as specified by the enclosed text.

As input, the AI model accepts the time-domain representation of the seismic wavefield. In this example, the input data is of shape 22×500×1 representing 22 sensors sampled for 0.5 seconds at 1000 Hz. As can be understood, other combinations and number of sensors can be used as the input data. The input shape raises two important points. First, the model has been trained using shot gathers emanating from a single source location located at the model's center. While it is expected that a model trained on multiple shot gathers will be capable of improved performance, it is not done so here as a simplification. Therefore, the results presented in this work, which we believe are still sufficient for geotechnical site investigation, should be considered a lower bound of the prediction accuracies that AI models for subsurface imaging will obtain. Second, the model has been trained assuming 11 receivers to the left and right of the source starting at a distance of 3 m and spaced at 2 m. In practice, as most digitizers can record 24 receivers simultaneously and setting up an array with constant spacing is easier than one with non-constant spacing, it is envisioned that a user can deploy a 24-channel array with a constant 2 m spacing when collecting data and then neglect the two receivers closest to the source location as part of signal preprocessing before performing the AI prediction.

After the time-domain representation of the seismic wavefield is provided, the AI model passes the data along two independent, parallel input pipelines to consider the time-domain (denoted as A* in FIG. 5A) and frequency-domain (denoted as B* in FIG. 5A) representations of the seismic wavefield. Along the A* path the time-domain data is down-sampled to 500 Hz and normalized by its maximum absolute value. Along the B* path the time-domain data is transformed to its frequency domain amplitude and scaled. The resulting shapes after the A* and B* transformations are 22×250×1. Both are passed to their own copy of the encoding path, denoted as P1. P1 comprises a series of convolution layers and maximum pooling layers, visually detailed in FIG. 5B. As is common practice, the channel dimension (i.e., the last dimension) of the convolutional layers increases in size as width and height (i.e., the first two dimensions) decrease as the data travels deeper into the network. The larger channel dimensions allow the network the ability to learn and store features to facilitate prediction. After P1 the data from both paths is concatenated in the channel dimension (denoted as C* in FIG. 5A) and passed to the decoding path, denoted at P2. P2 comprises two convolutional layers separated by a maximum pooling layer and followed by a global average pooling layer and two densely connected layers, visually detailed in FIG. 5C. After P2, the data is reshaped (denoted as D* in FIG. 5A) to the final output dimension of 20×50×1. The final output dimension of 20×50×1 represents a Vₛ image, 20 m deep by 50 m wide with a 1 m pixel size.

Developing the Training Set. Training the AI model architecture needs a large dataset of seismic waveforms propagated through known soil models. However, as no such experimental data exists, simulated data was relied upon to generate the initial training dataset. The first step of creating a simulated dataset is developing a framework to create complex, but realistic, subsurface models. To do so, consider that the properties of the subsurface vary naturally through space as a result of complex geological processes, and that such processes are not trivial to model. Instead, it was chosen to simulate their product rather than their process. A defining attribute of the near-surface (depths <30 m) is the potential for significant spatial variability in material properties. For example, consider the case of soft clay overlying limestone, the Vₛ of these materials can differ by two orders of magnitude, from 100 m/s to over 1000 m/s, and can change over a distance of less than a meter. Therefore, the ability to simulate rapid changes in material properties was considered of significant importance and a new model development framework was developed that supports this.

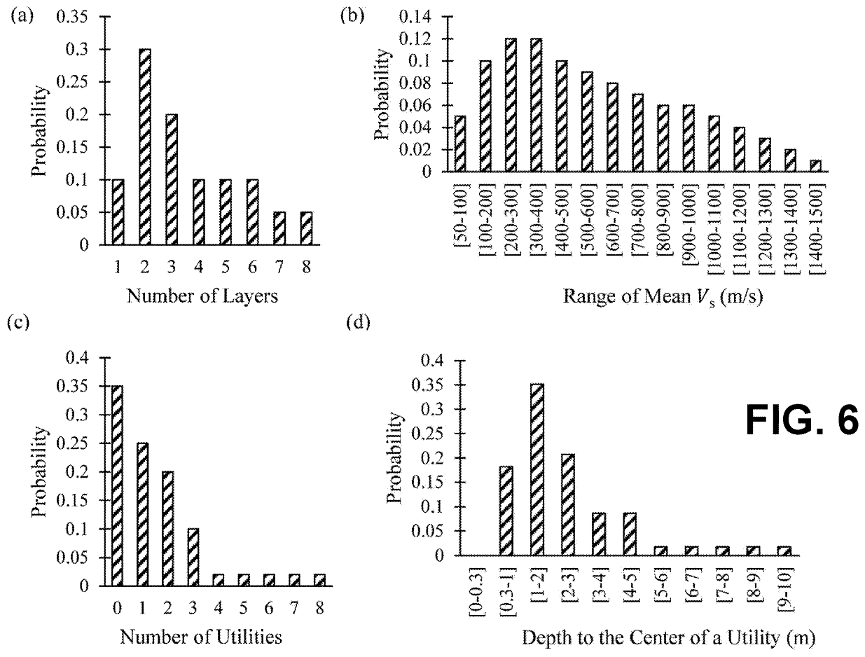

Overview of the Model Generation Framework. To simulate realistic subsurface conditions, prior model generation methodologies were built on to develop a novel model generation framework. The developed framework allows the user to define a 2D subsurface model of any size and resolution. Simulation of models of 60 m length (x) and 25 m depth (z) with a 1 m pixel size was chosen. The user defines the likelihood of a given number of layers per model with a probability mass function. For this study, it was chosen to simulate models with between one (i.e., homogenous) and eight layers (see plot (a) of FIG. 6 for the selected probability mass function). Once the number of layers is selected randomly according to the probability mass function, the layer boundaries can be developed with the user able to control the complexity of those layer interfaces through additional hyperparameters. With the layer boundaries defined, each layer can be populated with material properties assuming each layer is an independent laterally correlated random field. For the simulation of seismic waves, the material properties of interest were considered to be Vₛ, Poisson's ratio (v), and mass density (ρ). Note that material damping was not considered as a simplification. The mean values of Vₛ were selected from a probability mass function shown in plot (b) of FIG. 6, which captures the full range of near-surface Vₛ values. Lastly, the framework supports the injection of underground utilities that vary in terms of number (plot (c) of FIG. 6), size (up to 2 m diameter), and depth (plot (d) of FIG. 6). Note that the proposed framework is not conditioned to predict soil models between/around in-situ measurements (e.g., cone penetration test data), but rather the model generation framework seeks to provide a means to systematically generate diverse but geologically-realistic subsurface models. The model generation framework can be used to generate 100,000 subsurface models for training the AI model to perform the subsurface imaging task.

Layer Boundary Definition. After the definition of the model's size and resolution and the selection of the model's number of layers, the layer boundaries are defined. It was chosen to start each layer boundary at the left-side of each soil model (i.e., x=0), as shown by the filled circles in plot (a) of FIG. 7. The depth where these starting points are located is chosen at random, enabling a mixture of thin and thick layers across the dataset without explicitly setting minimum and maximum layer thicknesses. From those starting points, each boundary is generated by simulating a series of uniformly distributed random values, where each random value indicates the increment of vertical change between sampling points located across the width of the domain. The uniform distribution governing the increment of vertical change was limited to between −1.5 and 1.5 m and the sampling points were equally spaced at 1 m across the 60 m domain. Plot (a) of FIG. 7 shows a three-layered model after the initial generation of its layer boundaries. As can be observed in plot (a), the layer boundaries developed are quite rough and not consistent with standard geological processes (e.g., weathering). To smooth the rough layer boundaries, it can be filtered using, e.g., a Savitzky and Golay (1964) filter with a data window of 20 points and a 3^{rd} order polynomial. An example of the rough boundary after filtering is shown in plot (b) of FIG. 7. Finally, to mimic the geological processes of erosion and sedimentation, overlaps between boundaries can be resolved such that the interface defining the lower boundary is merged with the one defining the upper boundary over all overlapping sections. Plot (c) of FIG. 7 shows the boundaries from plot (b) after the boundary overlaps are resolved. Note that the middle boundary in plot (b) rises above the upper boundary between approximately 15 and 30 m, however after the interfaces are resolved in plot (c), the overlap is removed with overlying material being “deposited” over the “eroded” underlying material. The result of simulating the layer boundaries as independent random phenomena results in interactions between layers, such as thin material lenses, that can result in more realistic models than have been developed previously for AI model training.

Shear Wave Velocity Image Definition. After the layer boundaries have been defined, the Vₛ of each layer is simulated as an independent random field through a five-step process. First, the range of mean Vₛ values for each layer are randomly selected according to the probability mass function in plot (b) of FIG. 6. Second, a mean Vₛ value (μ_{V}_{ₛ}) is selected from the range of Vₛ values selected in the previous step. Third, the standard deviation of Vₛ (σ_{V}_{ₛ}) is computed using the relevant coefficient of variation of

$${V}_{s} \frac{{σ}_{{V}_{s}}}{{μ}_{{V}_{s}}}$$

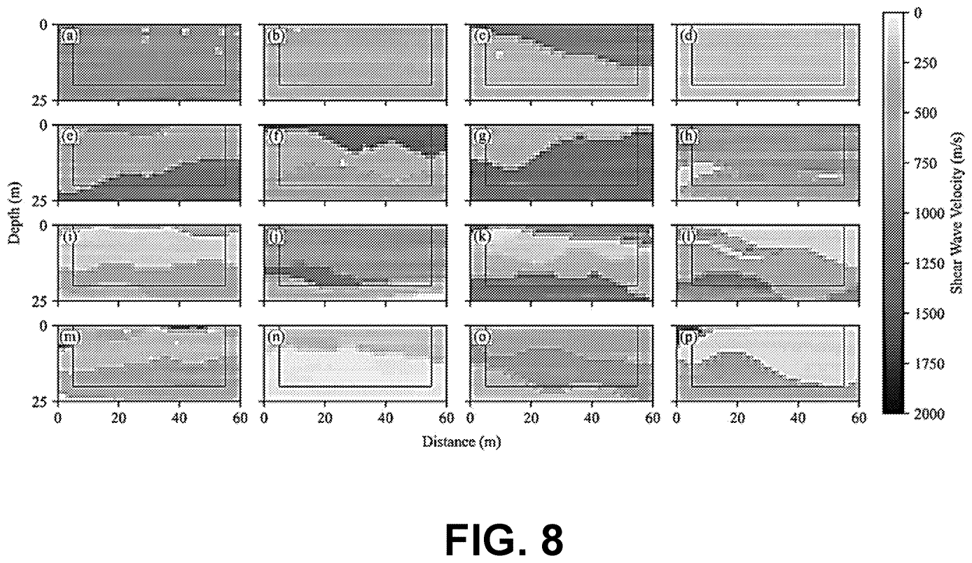

based on the mean Vₛ value, as described in Table 1. Fourth, to model realistic intra-layer variability each layer was modeled considering lateral correlation using an exponential correlation structure, where the correlation coefficient (P) between two points is defined by:

$$P ( Δ {x}_{v} , Δ {x}_{h} ) = exp ( - 2 ( \frac{\vert Δ {x}_{ν} \vert}{{λ}_{v}} + \frac{\vert Δ {x}_{h} \vert}{{λ}_{h}} ) , \qquad ( 1 )$$

where Δxᵥ and Δxₕ are the vertical and horizontal distances between two points and λᵥ and λₕ are the user-defined vertical and horizontal spatial correlation lengths, chosen as 100 and 0.5 m, respectively. Fifth, the μ_{V}_{ₛ}, σ_{V}_{ₛ}, and the correlation structure for each layer is used to define each layer's Vₛ structure. FIG. 8 represents 16 Vₛ images from the 10,000-member testing dataset. The Vₛ images are shown in order of increasing model complexity, where panels (a) and (b) are examples of models with a single layer whereas (o) and (p) were generated with eight layers. The thin red line defining a rectangular region to a depth of 20 m between 5 and 55 m, shown in all panels, is the portion of the Vₛ image to be predicted by the AI model architecture.

Compression Wave Velocity and Mass Density Image Definitions. To simulate the seismic wavefield (i.e., solve the elastic wave equation) the subsurface model's compression wave velocity (Vₚ) and mass density (p) images also need to be defined. While it would be possible to simulate Vₚ and p using the same process for Vₛ, instead it was chosen to relate Vₚ and p to Vₛ. For generating the Vₚ image, a Poisson's ratio (v) was randomly selected for each layer according to the mean Vₛ. v of soil and rock are quite different, see Table 1. With v defined, Vₚ can be computed from Vs with the relationship,

$${V}_{p} = {V}_{S} \sqrt{1 + \frac{1}{( 1 - 2 v )}} , \qquad ( 2 )$$

where all terms have been defined previously. For the ρ image, assume that ρ is constant for each layer and ranges from 2000 kg/m³ to 2100 kg/m³, depending upon the mean Vₛ of the soil layer, see Table 1.

TABLE 1
Ranges of material property values for the model generation framework.

| Symbol | Description | Range | |
|---|---|---|---|
| μ_{V}_{ₛ} | Mean shear wave velocity. | 50-1500 m/s (See Figure 2b for details) | |
| ${cov}_{{v}_{s}} = \frac{{σ}_{{V}_{s}}}{{μ}_{{V}_{s}}}$ | Coefficient of variation of shear wave velocity. | 0.05-0.15 0.05-0.20 | if > 1200 m/s if 460 < μ_{V}_{ₛ} ≤ 1200 m/s |
| | | 0.10-0.20 | if μ_{V}_{ₛ} ≤ 460 m/s |
| v | Poisson’s ratio. | 0.3-0.4 | if μ_{V}_{ₛ} > 460 m/s |
| | | 0.38-0.498 | if μ_{V}_{ₛ} ≤ 460 m/s |
| ρ | Mass density. | 2100 kg/m³ | if μ_{V}_{ₛ} > 760 m/s |
| | | 2050 kg/m³ | if 360 < μ_{V}_{ₛ} ≤ 760 m/s |
| | | 2000 kg/m³ | if μ_{V}_{ₛ} ≤ 360 m/s |
| d_{utility} | Utility diameter. | 0.5-2 m | |
| V_{s,utility} | Utility shear wave velocity. | 25-70 m/s | |
| V_{p,utility} | Utility compression wave | 340-1500 m/s | |
| | velocity. | | |
| ρ_{utility} | Utility mass density. | 800-2000 kg/m³ | |

Introduction of Utilities. To further add to the complexity of the generated subsurface models, small diameter anomalies are introduced consistent with underground utilities. Underground utilities are very common, especially in urban areas, and therefore it is likely that these will be encountered during field acquisition. While it is acknowledged that the frequencies and receiver spacings used here are not likely to be capable of detecting or resolving these utilities they may have an impact on the seismic wavefield and as such should be considered. For simplicity, utilities were assumed to be circular and homogenous, with uniform Vₛ, Vₚ, and ρ, as detailed in Table 1. The model generation framework allows a variable number of utilities to be generated per model, from 0 to 8, see plot (c) of FIG. 6; at different depths, from 0.3 to 10 m, see plot (d) of FIG. 6; with diameters between, 0.5 to 2 m see Table 1. Note that utilities with diameters less than 0.5 m are not considered as they cannot be modeled using the domain discretization (i.e., 0.25 m pixel) selected for the physics-based simulations described next.

Simulation of Synthetic Data Acquisition. Synthetic seismic wavefield data were generated for each subsurface model using the open-source, spectral-element-based software SPECFEM2D. Specifically, the elastic wave equation was solved under the assumptions of 2D plane strain and P-SV conditions. For the seismic source, a 30 Hz Ricker wavelet was simulated, which contains significant seismic energy in the 10 to 100 Hz range, representative of an impact-type source (e.g., sledgehammer) commonly employed in near-surface seismic data acquisition. The source was located at the center of the model at the surface (i.e., at 30 meters) and oriented vertically. The top boundary of the domain was treated as a free surface with zero-stress conditions, while the lateral and bottom boundaries were modeled using absorbing boundary conditions (ABCs). The computational domain was discretized into 0.25-m pixels to enable the propagation of short wavelengths. A sufficiently small-time step of 10 microseconds (1E-5 seconds) was employed to ensure numerical stability. The vertical component of particle velocity was recorded at 24 receiver locations, with 12 receivers on each side of the source. The receivers were spaced at 2-meter intervals, spanning from 7 to 53 meters from the source. Data were sampled at a time step of 1 millisecond (i.e., at 1000 Hz) over a duration of 1 second. The data were intentionally sampled faster than the minimum required by the Nyquist theorem so that when applied to field data the model could benefit from the reduced signal variance resulting from oversampling. Synthetic seismic data were generated for each of the 100,000 subsurface models to create a synthetic dataset of 100,000 seismic image-wavefield pairs.

AI Predictive Model Training. The design, training, and evaluation of the DL model architecture were facilitated by the Keras open-source Python package. Before training 100,000 seismic wavefield-image pairs were split into three sets: training (80%), validation (10%), and testing (10%). The training set was used to learn the model's parameters, the validation set was used to guide the selection of the model's architecture, and the testing set was used only at the very end to evaluate the AI model's performance. For the remainder of this work, the focus will only be on the performance of the model on the testing set, and from examples drawn from the testing set, as it is the only objective measure of the AI model's performance. As the Keras package handles the details of constructing the model's raw structure and optimizing the model's weights, the focus here is on the preprocessing, data-augmentation, and hyperparameter tuning performed to develop a model that creates robust predictions on real data.

Preprocessing of the seismic wavefield. Field data are inherently more complex than simulated data and, as such, a series of preprocessing techniques were investigated to better align field data with the simulated data on which the AI model was trained. Through an iterative process, a five-step preprocessing workflow was selected. First, as discussed previously, the two receivers closest to the seismic source was excluded creating a distance between the source and the first receiver in each direction of 3 m. This was done for two reasons: (1) when collecting field data with an impact source it was found that, at times, it was unavoidable to over-range or “clip” geophones located 1 m from the source and (2) the response of these receivers, even when not over-ranged, are very different in terms of their relative amplitude when compared with numerical simulations. While the former is the result of hardware limitations that may be resolved with different equipment, the latter may be the result of physical phenomena. In particular, these differences in relative amplitude may be attributable to near-field effects and/or shear-strain induced non-linearities of soil properties as a result of the non-elastic deformations observed after each hammer impact. Despite the source, they are not observed in the seismic simulations and that by excluding these two closest receivers it was possible to substantially improve the model's performance on the data consistency tests developed later in this work. Second, any mean offset from the remaining 22 receiver traces were removed by subtracting their trace-by-trace mean value. Third, in preparation for time-domain filtering and Fourier transformation, the beginning and ending 20 ms of the seismic trace were tapered with a Tukey window. Fourth, the seismic traces are normalized by their maximum absolute value such that the maximum value of all waveforms is between −1 and 1, but the relative amplitude between traces was maintained. Fifth, the seismic wavefield was filtered using a 5^{th}-order Butterworth bandpass filter between 20 and 50 Hz.

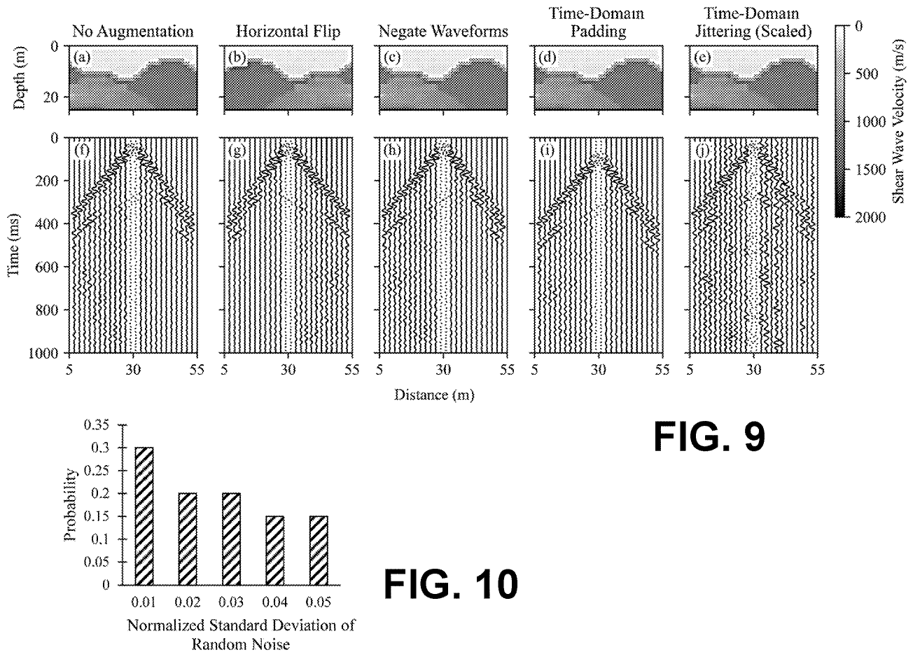

Data Augmentation. Data augmentation is a process of creating diverse variations of the training data by transforming the input such that the output data remains the same or changes in a predictable way. These data augmentations are typically performed on-the-fly during model training and result in the model seeing a more-diverse dataset. As a result, the model learns to handle a wider (and more realistic) range of input data that helps prevent model overfitting. For this study, four data augmentation techniques were used, three of which had not been used previously. FIG. 9 presents the four data augmentations for a single, randomly selected, Vₛ-image wavefield pair. The default Vₛ image and wavefield are shown in plots (a) and (f), respectively. Technique 1 is the horizontal flip, it involves flipping the Vₛ image and associated seismic wavefields about the center of the model. This technique, originally proposed for data-driven seismic imaging, simulates a change in perspective when viewing the seismic image and associated seismic wavefield, see plots (b) and (g) of FIG. 9. The horizontal flip augmentation was randomly applied to 50% of the data during each training epoch.

Technique 2 is negate waveforms, it involves multiplying the waveform amplitudes by a negative one and no change to the Vₛ image, see plots (c) and (h) of FIG. 9. The negate waveforms augmentation corrects for potential differences between geophone polarities between manufacturers, as the meaning of positive and negative is only a function of the geophone wiring and not the properties of the Vₛ image. The negative waveform augmentation was applied to 50% of the data during each training epoch. Technique 3 is time-domain padding, it involves shifting the recorded signals in time by adding zeros at the start of all waveforms recorded by the receivers and no change to the Vₛ image, see plots (d) and (i) of FIG. 9. The time-domain padding augmentation simulates potential delays and/or early triggering of the seismic source that can be the result of different field equipment hardware or data acquisition settings. In each epoch, this augmentation was randomly applied to all data pairs with a maximum shift of +/−50 ms. Technique 4 is time-domain jittering, it involves injecting random white noise with zero mean and a variable standard deviation to each seismic trace and no change to the Vₛ image, see plots (e) and (j) of FIG. 9. Time-domain jittering was applied to every trace independently with a randomly selected standard deviation.

The selected standard deviation is the product of the normalized standard deviation selected from the probability mass function shown in FIG. 10 and the absolute maximum amplitude of the original seismic wavefield. The addition of time-domain jittering seeks to replicate the small amplitude noise typical of seismic wavefield gathers even after time-domain stacking has been performed in the field. As such the amount of noise is relatively small, and as such, the amplitude of the noise was increased by a factor of 20 in plot (e) of FIG. 9 so that it can be more-easily viewed. The effect of these data augmentations were qualitatively and quantitatively examined in terms of their effect on predictive model performance in the Prediction Consistency Tests.

Hyperparameter Tuning. Hyperparameter tuning involves systematically varying the parameters that control the optimization of the model's training and assists in achieving optimal model performance. For the hyperparameter tuning, the following parameters were systematically varied within the specified limits to find optimal settings as judged by the model's performance on the validation set. The hyperparameters that were considered included: learning rate (from 0.1 to 0.00001), learning rate decay (various functional forms), minibatch size (from 8 to 128), optimization algorithms (Adam and stochastic gradient descent), and number of epochs (from 40 to 80). Ultimately, a learning rate of 0.001, an exponential learning rate decay with a factor of 0.1 after 10 epochs, a minibatch size of 32, the Adam optimization algorithm, and 60 training epochs were selected. The model was trained using a mean absolute error (MAE) between the predicted and true Vₛ image, because MAE is less sensitive to outliers than other regression-type loss functions (e.g., mean squared error).

After hyperparameter tuning, the best-performing combination resulted in an MAE of 95 m/s on the validation set. While the validation set MAE is not a fully objective measure of the model's performance it gave confidence to proceed with finalizing the model's development. It is important to highlight that the development of the model is different from those of “Using convolutional neural networks to develop starting models for near-surface 2-D full waveform inversion” by Vantassel et al. (Geophys J Int 231, 72-90, 2022) and “A frequency-velocity CNN for developing near-surface 2D vs images from linear-array, active-source wavefield measurements” by Abbas et al. (Comput Geotech 156, 105305, 2023) as we did not normalize the Vₛ image during training, but rather make predictions directly in the Vₛ space. As a consequence, the MAE values cannot be directly compared with theirs. Therefore, to demonstrate the performance of the newly proposed model relative to those previously developed, a modified version of the Vantassel et al. (2022) architecture was retrained using the newly generated dataset. Note that all procedures described above for developing the model, including data preparation, data augmentation, and hyperparameter tuning were also performed for the modified Vantassel et al. (2022) architecture to, as fairly as possible, compare the architectures of the two models.

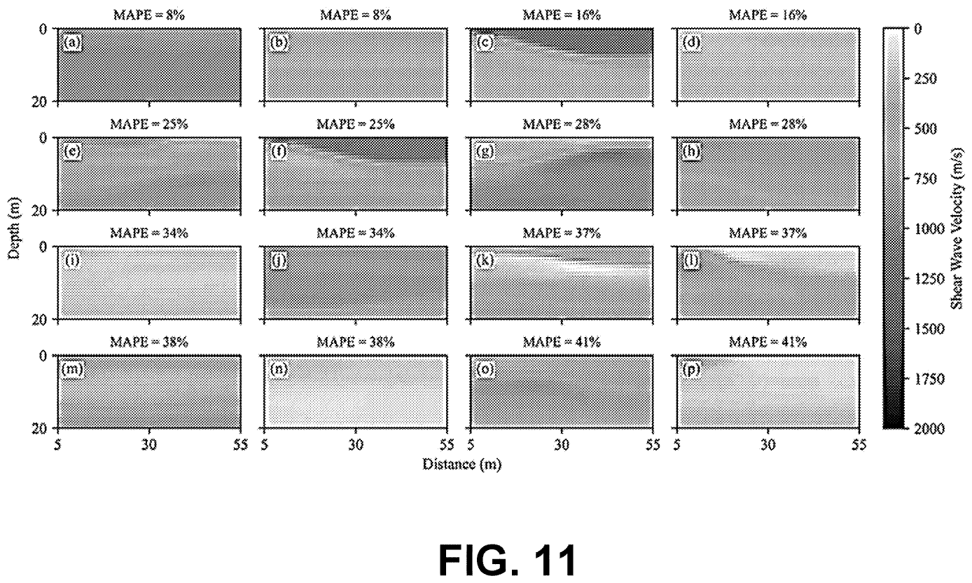

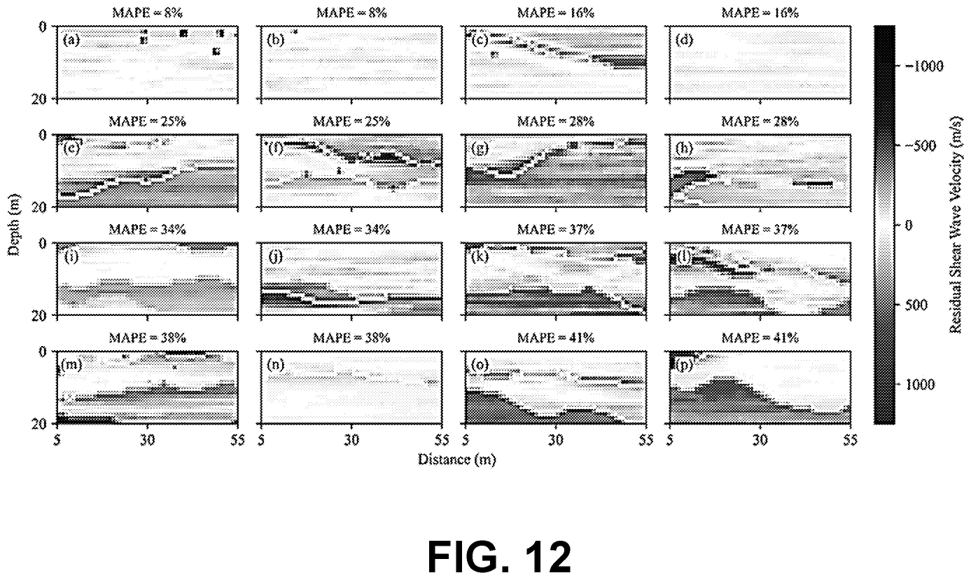

Evaluation of the AI Predictive Model. After final training, the AI predictive model was evaluated on the 10,000 seismic wavefield-image pairs of the testing set. Consider both qualitative and quantitative evaluations of the AI model's performance. For a qualitative evaluation of the model's predictive ability, FIG. 11 presents the AI model's prediction of the 16 Vₛ images whose true Vₛ images were presented previously (in the same order) in FIG. 8. Recall these figures show models of increasing complexity from homogenous examples in plots (a) and (b) of FIG. 11 to heterogeneous, 8-layered examples in plots (o) and (p) of FIG. 11. Note that these models were not selected purely at random, rather they were selected as they most-closely represent the average performance of the AI predictive model on predicting models with the specified number of layers. In general, consistency was observed with the major layer interfaces occurring in the upper 15 m with deeper interfaces (between 15 and 20 m) being difficult for the model to capture. To show this more clearly, FIG. 12 shows the pixel-by-pixel residual Vₛ (i.e., V_{s,true}−V_{s,predicted}) for the same 16 Vₛ images. In general, darker colors, indicating larger error, were observed at depths below 15 m and within approximately 5 m from the model's left and right edges. These larger errors may be attributed to the use of a single source position at the model's center. This may be remedied with the incorporation of multiple sources. In terms of quantitative evaluation, the mean absolute percent error (MAPE) for each prediction was included above its corresponding panel in FIGS. 11 and 12. The MAPE for the selected sampling of the testing set ranges from 8% to 41%, with increasing MAPE corresponding to the more complex models. Across the entire 10,000-member testing set the average MAPE was found to be 24%.

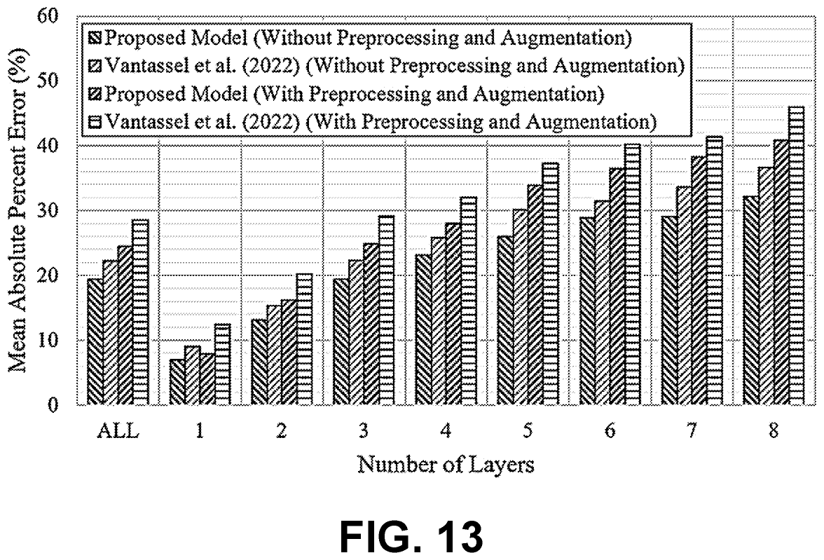

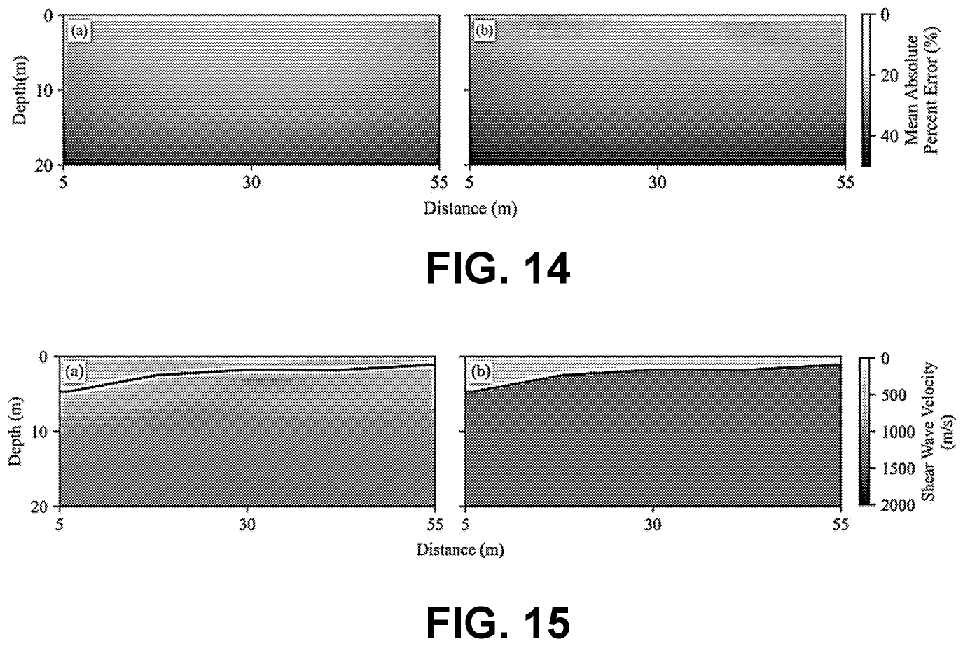

In addition, the model's predictive ability was compared to the CNN model developed by Vantassel et al. (2022). Recall that a new version of the Vantassel et al. (2022) architecture was developed and retrained using all of the data preprocessing and augmentation steps discussed above. Therefore, when the new predictive model was compared with that by Vantassel et al. (2022), that comparison is purely on the basis of model architecture as both were trained on the same data and in the same manner. The new Vantassel et al. (2022) model was tested on the 10,000-member testing set and found the average MAPE to be approximately 28%, 4% higher than the newly proposed model (see FIG. 13). Therefore, it can be concluded that the newly developed architecture is an improvement on that developed previously. To investigate how the two predictive models differ the average MAPE was computed across the entire testing set pixel-by-pixel, see FIG. 14. It was observed that on average the MAPE of the newly proposed model is lower than that of the Vantassel et al. (2022) model (i.e., the image has lighter colors) and that the newly proposed model errors are lower to greater depths than the Vantassel et al. (2022) model. FIG. 14 indicates that the newly proposed model's increase in performance is primarily concentrated on improving the model's predictive performance at depth (i.e., depths between 10 and 15 m). Moreover, it can be observed that the most reliable portion of the AI model's Vₛ predictions are in the central 40 m of the model and to a depth of 15 m.

While looking at the average performance across the entire dataset is informative, understanding how the AI model's predictive ability changes as a function of subsurface complexity is also interesting. So, the average MAPE across the testing set was also computed broken down by the number of layers in the subsurface, see FIG. 13. In general, it was observed that as the number of layers in the subsurface increases (i.e., as subsurface model complexity increases) the average MAPE increases. For the proposed AI model with preprocessing and augmentation, the average MAPE is approximately 8% when the subsurface is homogenous and 41% when the subsurface is eight-layered. If typical subsurface profiles are considered to be those with three or fewer layers, the average MAPE of the predictions is less than approximately 20%. The proposed AI model also outperforms the Vantassel et al. (2022) AI model not only on average but also across various layers of model complexity. Lastly, in FIG. 13, the effect of data preprocessing and augmentation on the AI model can be considered. By adding preprocessing and augmentation, the AI model's prediction task is made more challenging. However, these steps appear to aid in successful predictions on real data. To quantify the weakening effect that the preprocessing and augmentation have on the AI model's predictive performance a new version of the proposed model and a new version of the Vantassel et al. (2022) model was trained without these steps in place and their performance on the testing set was summarized, see FIG. 13. The average increase in MAPE when including preprocessing and data augmentation is approximately 5% (i.e., an increase from 19% to 24%). Nonetheless, this predictive accuracy on synthetic data is sacrificed in exchange for more robust predictions on real data and better performance on the consistency tests.

Field Application and Verification. To evaluate the AI model's potential to predict Vₛ images of the subsurface from real data, a dataset acquired at a test site is presented. Field data acquisition involved deploying 24, 4.5 Hz vertical geophones coupled to the ground surface with a 7.6-cm aluminum spike at a 2 m spacing (e.g., array lengths of 46 m). Seismic data were generated using five impacts with a 20-lb sledgehammer on an aluminum strike plate at the array's center (23 m). The seismic wavefield data from the five sledgehammer impacts recorded on each receiver were stacked in the time-domain to minimize incoherent noise and increase the signal-to-noise ratio.

Before the stacked field recordings could be used for predicting the subsurface Vₛ image, they were first corrected for 3D effects. The 2D, P-SV simulations described above consider the source to be a line source oriented perpendicular to the array. However, the sledgehammer impacts used in practice are more representative of a point source and must therefore be corrected for the differences in propagation pattern and radiation damping. Herein, a correction procedure (“Line-source simulation for shallow-seismic data. Part 1: theoretical background” by Forbriger et al. Geophys J Int 198, 1387-1404, 2014) using an in-house implementation of their algorithm benchmarked against the Lisousi software developed by Forbriger et al. was utilized. In brief, the correction involves three main steps-convolution of the seismic waveforms with \sqrt{1/t}, application of a \sqrt{1/t} time-domain taper, and scaling the waveform with r_{offset} \sqrt{2}, where t is travel time and r_{offset} is the source-to-receiver offset. While the correction procedure alleviates some of the 3D effects present in the seismic wavefield, the correction is not exact and as a result leaves some artifacts in the seismic records. Nonetheless, the correction is used as it is state-of-the-art. After applying the 3D-to-2D correction, the field waveforms are pre-processed and readied for use in the AI predictive model.

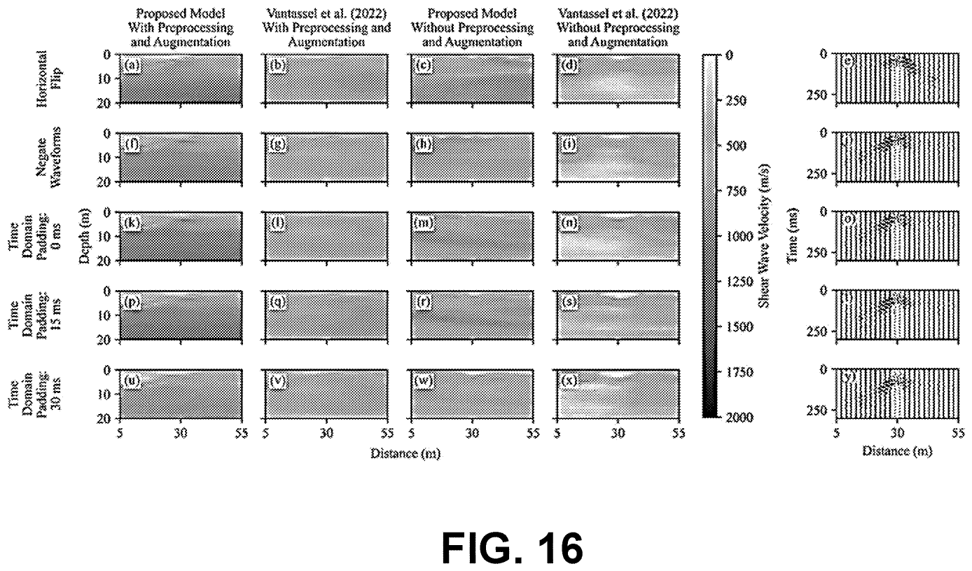

Plot (a) of FIG. 15 depicts the Vₛ image predicted by the AI model at the test site. The Vₛ image comprises soft soil overlaying rock with a strongly dipping interface. Local geology indicates the site comprises alluvium (a mixture of sand and clay) overlying soft rock (limestone). Therefore, the predicted Vₛ image was considered to be consistent with local geology. However, to more quantitatively evaluate the model's prediction, surface wave testing and shear-wave (S-wave) refraction were performed along the same transect. For surface wave testing, both Rayleigh and Love MASW were performed to develop a 1D Vₛ profile for the site. Note that there was insufficient space at the testing location for 2D MASW to be performed. When collecting both Rayleigh and Love MASW data, the same 24-channel array was used with five source locations (between 1 and 20 m) off of both ends of the array. When processing the MASW data, consistent phase velocity estimates could not be extracted from both ends of the array and therefore it was not possible to determine a 1D Vₛ profile at the site. While unfortunate, these findings are consistent with a site with large lateral variability (i.e., a non-1D site). For S-wave refraction data acquired along the same 24-channel array as was used for the AI-predictive model. Using S-wave refraction for 2D imaging was only possible at this site because (1) the site was normally dispersive (i.e., Vₛ strictly increases with depth) and (2) the profile was relatively simple with a strong Vₛ contract. Data were acquired using a weighted shear plank and a sledgehammer at five shot points: two one meter from the ends of the array, two at quarter points of the array, and one at the midpoint of the array. The resulting low-resolution Vₛ image from S-wave refraction is shown in Plot (b) of FIG. 16. Consistency between the Vₛ from the AI predictive model and the S-wave refraction test was observed in terms of the near-surface and rock velocity and the soil-rock interface. To more clearly compare the boundaries between the soil and rock layer, the boundary determined from S-wave refraction on the 2D Vₛ image from the AI predictive model was superimposed. The interface was shown to be consistent between the AI predictive model and the S-wave velocity image with the AI predictive model showing a more-rounded interface between approximately 10 and 20 m along the profile. While it is difficult to exactly determine which is the true answer, it is believed that the AI predictive model provides an actionable determination of the ground surface, which would be of value during geotechnical site investigation, by indicating that the site comprises soil over rock with substantial lateral variability. Two approaches were investigated for evaluating the AI predictive model when the true Vₛ model is unknown, and these are termed prediction consistency tests and presented as follows.

Prediction Consistency Tests. As a matter of practicality, the AI predictive model was developed using synthetic data, however, the use of synthetic data is based on two assumptions: the source type, which is assumed to be a 30 Hz Ricker wavelet, and the underlying physics, which is assumed linear elasticity. These assumptions, while reasonable, cannot be verified using solely the AI model. Furthermore, the AI model's predictions do not provide a means to quantify their accuracy when the true Vₛ image is unknown. Stated differently, it cannot be verified if the AI model has learned the correct mapping between the seismic wavefield and the Vₛ image or if it is hallucinating. As such two tests were developed, termed prediction consistency tests, for evaluating the AI model's predicted Vₛ image when the true Vₛ image is unknown to qualitatively evaluate the model's Vₛ image predictions. If the AI predictive model does not provide consistent predictions on both tests then the AI predictive model is considered not to have learned the appropriate mapping and the Vₛ image must be considered cautiously.

Prediction Robustness Test. The first prediction consistency test evaluates the sensitivity of the AI model's prediction to three of the four augmentations presented above: horizontal flip, negate waveforms, and time-domain padding. Recall that during training the AI model was exposed to these augmentations and, if the model is well-trained, it should exhibit a robustness to these transformations. Therefore, to test the model's predictions when the true Vₛ image is unknown these transformations can be applied to the data collected in the field and the consistency of the AI model's predictions examined. If the AI model's predictions are the same (or very similar) the AI model can be considered to have passed the prediction consistency test. FIG. 16 illustrates the prediction consistency test applied to the data collected at the test site. The rows of the figure represent predictions influenced by (1) horizontal flip (note the model is flipped back after prediction to facilitate comparison), (2) negate waveforms, (3) time lags of 0 ms (i.e., the baseline), (4) time-domain padding of 15 ms, and (5) time-domain padding of 30 ms. The first four columns compare the AI predictive models developed through this study, from left to right they are: (1) the proposed model with preprocessing and augmentation, (2) the Vantassel et al. (2022) model with preprocessing and augmentation, (3) the proposed model without preprocessing and augmentation, and (4) the Vantassel et al. (2022) model without preprocessing and augmentation. The final column shows the associated seismic wavefields after the associated augmentation. The first two columns of FIG. 16 (i.e., the models with preprocessing and augmentation), show consistency between the model's predictions, whereas the middle two columns (i.e., the models without preprocessing and augmentation) do not. The conclusion being that the addition of preprocessing and augmentation results in more robust and reliable predictions than those without. Therefore, the use of preprocessing and augmentation is strongly encouraged when developing AI prediction models for subsurface imaging. The use of the prediction robustness test proposed here is also strongly encouraged to check model predictions.

Wavefield Prediction Consistency Test. The second prediction consistency test evaluates the AI model's stability through the iterative application of physics-based simulation. For this consistency test, a prediction is initially made on the field seismic data, giving what the AI model believes is the subsurface Vₛ image. In a process similar to traditional FWI, a synthetic seismic wavefield is then simulated in that predicted model using the physics-based solver (i.e., SPECFEM2D). At this stage, the simulated waveforms can be compared to the waveforms collected in the field, however because of the assumptions about source type and underlying physics they will generally not be identical. So instead the first iteration of the wavefield prediction consistency test can be performed where the simulated seismic wavefield is taken and a new Vₛ image predicted using the AI model. This process can then be repeated a second time by taking the new Vₛ image and simulating a new seismic wavefield and an associated new Vₛ image. When the test is complete, three sets of seismic wavefields (i.e., one from the field and two from simulation) and three Vₛ images (i.e., one predicted by the AI model from the field data and two predicted by the AI model from the simulated data) have been formed. To assess if the model passed the wavefield prediction consistency test, the similarity of the Vs images. If the AI model has learned the correct pairing between the observed seismic wavefield and the Vₛ image, it should produce consistent Vₛ images from the three seismic wavefields. Second, the similarity of the three seismic wavefields can be compared. Again, consistency should be expected, with the latter two simulated wavefields being the most similar as they share consistent assumptions in terms of source wavelet and underlying physics. If we do not observe consistency in the Vₛ images and seismic wavefields, the AI model's prediction does not pass the wavefield prediction consistency test.

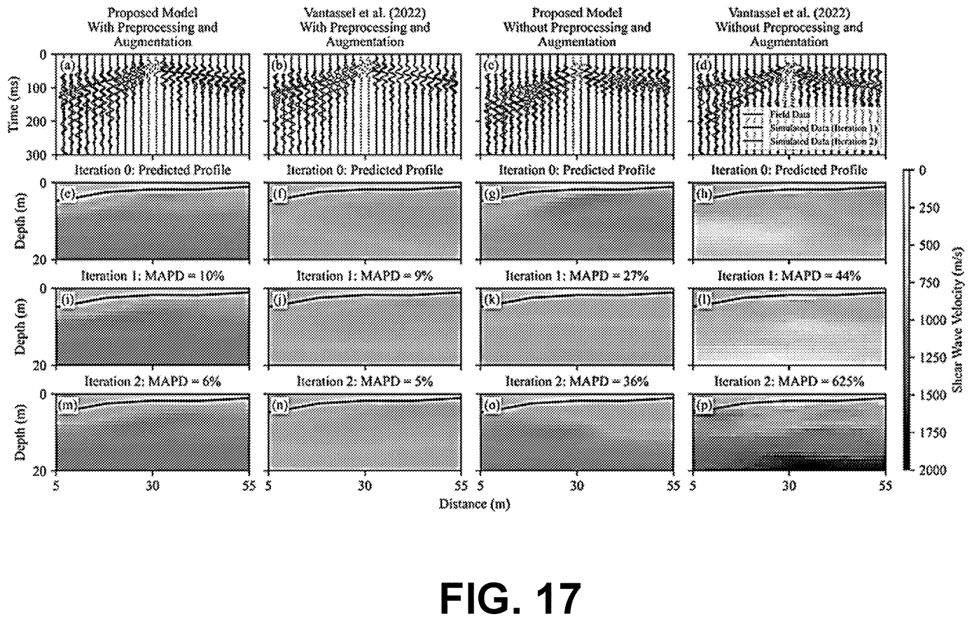

FIG. 17 illustrates the result of the wavefield prediction consistency test conducted on the field data collected at the test site. The three seismic images presented in plots (e), (i), and (m) of FIG. 17 represent the AI model's prediction on the field dataset, on the simulated data after the first iteration, and on the simulated data after the second iteration, respectively. The three iterations are consistent, with mean absolute percentage difference (MAPD) between the predicted Vₛ image and the Vₛ image from the previous iteration being less than 10%. This indicates that the AI model has effectively captured the essential underlying phenomena and has produced a reliable prediction. Above the seismic images, see plot (a) of FIG. 17, is a comparison of the seismic wavefields for the proposed model. The waveforms generated across multiple iterations show a general consistency. A strong consistency between the field and simulated data was observed to the right of the source, with some stronger inconsistencies observed on the left side of the source. Of particular note, are the significant amplitudes extending to 300 ms duration in the field data, these are not observed in the simulated data, with the wavefield energy in the simulated data only extending to approximately 150 ms. These large amplitudes occurring late in the seismic record of the field data may be attributed to the result of reflected surface waves traveling back along the array. In terms of geologic structure, the dip observed on the left side of the Vₛ image can be a filled river channel and therefore the observed wavefields are the result of reflections off of the opposite side of the channel where the underlying limestone rises back up toward the ground surface. Remarkable consistency was observed between the simulated seismic wavefields indicating that the Vₛ images predicted by the AI model are consistent with the underlying physics and produce reliable results. Due to the consistency of the predicted Vₛ images and the seismic wavefields, the proposed model is considered to pass the wavefield prediction consistency test.

Finally, the performance of the other models developed in this study on the wavefield prediction consistency test are presented alongside the proposed model in FIG. 17. The second, third, and fourth columns of FIG. 17 present the wavefield prediction consistency test results for the model by Vantassel et al. (2022) with preprocessing and data augmentation, the proposed model without any preprocessing or data augmentation, and the model by Vantassel et al. (2022), without any preprocessing or augmentation steps, respectively. FIG. 17 indicates that like the proposed model with preprocessing and augmentation, Vantassel et al. (2022) with preprocessing and augmentation passes the wavefield prediction consistency test, with values of MAPD less than 10%. However, while the update Vantassel et al. (2022) model passed the wavefield prediction consistency test, the proposed model is still preferred as the average predictions are more accurate (recall FIG. 13). For the two models without preprocessing and data augmentation, the models fail the wavefield prediction test. The predicted Vₛ images are inconsistent as evidenced by MAPD values increasing on each iteration up to 625% for the Vantassel et al. (2022) model without preprocessing and augmentation. These examples confirm that the preprocessing and data augmentations proposed in this work serve an important role in improving the model's ability to generalize and develop consistent predictions. Furthermore, the use of the wavefield prediction consistency test allows for these instabilities to be identified even when the true Vₛ images are unknown.

With reference to FIG. 18, shown is a schematic block diagram illustrating an example of processing or computing circuitry 1800. In some embodiments, among others, the processing or computing circuitry 1800 may include a processing or computing device such as, e.g., a smartphone, tablet, computer, etc. As illustrated in FIG. 18, the processing or computing circuitry 1800 can include, for example, a processor 1803 and a memory 1806, which can be coupled to a local interface 1809 comprising, for example, a data bus with an accompanying address/control bus or other bus structure as can be appreciated. To this end, the processing or computing circuitry 1800 may comprise, for example, at least one server computer or like device, which can be utilized in a cloud-based environment. In some embodiments, the processing or computing circuitry 1800 can include one or more network interfaces that may comprise, for example, a wireless transmitter, a wireless transceiver, and a wireless receiver. The network interface can communicate to a remote computing device using, e.g., a Bluetooth protocol or other wireless protocol.

In some embodiments, the processing or computing circuitry 1800 can include one or more network/communication interfaces. The network/communication interfaces may comprise, for example, a wireless transmitter, a wireless transceiver, and/or a wireless receiver. As discussed above, the network interface can communicate to a remote computing device using a Bluetooth, WiFi, or other appropriate wireless protocol. As one skilled in the art can appreciate, other wireless protocols may be used in the various embodiments of the present disclosure. In addition, the processing or computing circuitry 1800 can be in communication with a sensing capsule 203 (FIG. 2) and/or one or more surface or near-surface sensor(s) 1812 such as, e.g., velocity transducers (e.g., geophones), accelerometers, distributed fiber optic sensing (DFOS) or distributed acoustic sensing system (DAS). In some implementations, sensing capsule 203 and/or surface or near-surface sensor(s) 1812 can be coupled to the processing or computing circuitry 1800 and can interface through the local interface 1809.

Stored in the memory 1806 can be both data and several components that are executable by the processor 1803. In particular, stored in the memory 1806 and executable by the processor 1803 can be a 1815 and potentially other application program(s). Also stored in the memory 1806 may be a data store 1818 and other data. In addition, an operating system 1821 may be stored in the memory 1806 and executable by the processor 1803. The memory is defined herein as including both volatile and nonvolatile memory and data storage components. Volatile components are those that do not retain data values upon loss of power. Nonvolatile multiphysics intelligent sensing system (MISS) application components are those that retain data upon a loss of power. Thus, the memory 1806 may comprise, for example, random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, optical disc such as compact disc (CD) or digital versatile disc (DVD), magnetic tapes accessed via an appropriate tape drive, holographic storage, and/or other memory components, or a combination of any two or more of these memory components. In addition, the RAM may comprise, for example, static random-access memory (SRAM), dynamic random-access memory (DRAM), or magnetic random-access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1803 may represent multiple processors 1803 and/or multiple processor cores (e.g., of a graphics processing unit), and the memory 1806 may represent multiple memories 1806 that operate in parallel processing circuits, respectively. In such a case, the local interface 1809 may be an appropriate network that facilitates communication between any two of the multiple processors 1803, between any processor 1803 and any of the memories 1806, or between any two of the memories 1806, etc. The local interface 1809 may comprise additional systems designed to coordinate this communication, including, for example, performing calibrations. The processor 1803 may be of electrical or of some other available construction.

A number of software components can be stored in the memory 1806 and can be executable by the processor 1803. An executable program may be stored in any portion or component of the memory 1806. In this respect, the term “executable” means a program file that is in a form that can ultimately be run by the processor 1803. Examples of executable programs may be, for example, a compiled program that can be translated into machine code in a format that can be loaded into a random access portion of the memory 1806 and run by the processor 1803, source code that may be expressed in proper format such as object code that is capable of being loaded into a random access portion of the memory 1806 and executed by the processor 1803, or source code that may be interpreted by another executable program to generate instructions in a random access portion of the memory 1806 to be executed by the processor 1803, etc. In particular, stored in the memory and executable by the processor can be a vehicle category classification program, an operating system and potentially other applications. Also stored in the memory may be a data store and other data. It is understood that there may be other applications that are stored in the memory and are executable by the processor as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

Although the MISS application 1815 and other application program(s) or systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein. Also, any logic or application described herein, including the MISS application 1815, that comprises software or code can be embodied in any non-transitory computer-readable medium for use by or in connection with an instruction execution system such as, for example, a processor 1803 in a computer system or other processing circuitry, device or system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The MISS application 1815, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the certain embodiments of the present disclosure includes embodying the functionality of the preferred embodiments of the present disclosure in logic embodied in hardware or software-configured mediums.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A system for multiphysics sensing during subsurface drilling, comprising:
a sensing capsule coupled between a drill string and a drilling bit, the sensing capsule comprising an electromagnetic sensing system and a seismic sensing system; and
at least one computing device communicatively coupled to the sensing capsule, the at least one computing device comprising a processor and memory storing a multiphysics intelligent sensing system (MISS) application that when executed by the processor causes the at least one computing device to:
obtain sensor data from the electromagnetic sensing system and the seismic sensing system during drilling along a route;
determine the presence or absence of an obstruction along the route based at least in part upon the sensor data from the electromagnetic sensing system and the seismic sensing system, the determination provided by a trained intelligent obstruction model; and
providing an indication of the obstruction to an operator of the drill string and drill bit.

2. The system of claim 1, wherein the electromagnetic sensing system comprises a look-ahead radar system.

3. The system of claim 2, wherein the look-ahead radar system is a pulsed radar or a frequency modulated continuous wave (FMCW) radar.

4. The system of claim 1, wherein the seismic sensing system comprises a mechanical shaker configured to produce an impulse and one or more sensors distributed about the sensing capsule.

5. The system of claim 4, wherein the one or more sensors comprise one or more accelerometer, one or more geophone, or both.

6. The system of claim 1, further comprising a surface or near-surface sensor communicatively coupled to the at least one computing device, wherein the presence or absence of an obstruction along the route is further determined based upon sensor data from the surface or near-surface sensor.

7. The system of claim 6, wherein the surface or near-surface sensor is a distributed acoustic sensing system (DAS).

8. The system of claim 7, wherein the DAS comprises three or more sensors providing sensor data.

9. The system of claim 1, wherein the trained intelligent obstruction model comprises parallel frequency and time domain paths that are concatenated together.

10. The system of claim 9, wherein the trained intelligent obstruction model is initially trained with simulated subsurface data.

11. The system of claim 9, wherein the trained intelligent obstruction model comprises a plurality of convolutional layers.

12. The system of claim 9, wherein the trained intelligent obstruction model determines a distance to the obstruction.

13. The system of claim 12, wherein the trained intelligent obstruction model determines a size of the obstruction.

14. The system of claim 9, wherein the trained intelligent obstruction model determines a composition of the obstruction.

15. A method for multiphysics sensing during subsurface drilling, comprising:
receiving, by a processing device, sensor data from a sensing capsule coupled between a drill string and a drilling bit during drilling along a route, the sensing data comprising electromagnetic sensing data and stress wave sensor data;
detecting, by a multiphysics intelligent sensing system (MISS) application executed by the processing device, the presence of an obstruction along the route based at least in part upon the sensor data;
in response to the detection of the obstruction, providing a distance and direction from the drilling bit to the obstruction; and
adjusting operation of the drill string and drilling bit to change the route and avoid the obstruction.

16. The method of claim 15, wherein the electromagnetic sensing data comprises pulsed radar data.

17. The method of claim 15, wherein the stress wave sensor data comprises impulse data generated by a mechanical shaker.

18. The method of claim 15, further comprising receiving sensor data from a distributed acoustic sensing system (DAS) disposed on or near a surface.

19. The method of claim 18, wherein the MISS application comprises a trained intelligent obstruction model detects the presence of the obstruction based upon the received sensor data.

20. The method of claim 15, comprising providing a visual indication of the obstruction with respect to the drilling bit.
